(19) United States
(12) Patent Application Publication
(10) Pub. No.: US 2016/0180337 A1
(43) Pub. Date: Jun. 23, 2016

(54) COMPLIANCE ENHANCEMENTS DUE DILIGENCE AT STAGING

(71) Applicant: Moneygram International, Inc., Minneapolis, MN (US)

(72) Inventors: Erika Joann Cline, Frisco, TX (US); Angela Marie Runkle, Maple Grove, MN (US); Lisa Marie Minogue, Forest Lake, MN (US); Elena Kuznetsov, Eden Prairie, MN (US)

(21) Appl. No.: 14/581,283

(22) Filed: Dec. 23, 2014

(51) Int. Cl. G06Q 20/38; G06Q 20/10

(52) U.S. Cl. CPC G06Q 20/38; G06Q 20/10

(57) ABSTRACT

A method includes receiving a request for a money transfer transaction. The request includes staging information that includes an identity of the party to the money transfer transaction. The method includes determining whether to place a hold on the money transfer transaction based, at least in part, on the staging information. When a hold is placed on the money transfer transaction, the method includes initiating one or more due diligence operations to determine whether to remove the hold on the money transfer transaction. The method includes, providing confirmation information to the party if the hold is removed. The confirmation information may authorize the party to participate in the requested money transfer transaction. The due diligence operations may be performed prior to the party interacting with (e.g., providing funds to or receiving funds from) a money transfer agent at a money transfer location.

### TECHNICAL FIELD

The present disclosure relates to providing money transfer transactions. In particular, the present disclosure is related to systems, methods, computer-readable storage media, and apparatuses for authorizing money transfer transactions in compliance with one or more regulatory requirements imposed on a money transfer entity.

### BACKGROUND

Government agencies impose numerous regulatory requirements on money transfer entities in connection with providing money transfer transaction services. Compliance with the regulatory requirements creates a substantial burden on money transfer entities, increasing the operating costs of the money transfer entities. Additionally, compliance with the regulatory requirements often delays completion of money transfer transactions, and may result in cancellation of a money transfer transaction. Furthermore, failure to comply with the regulatory requirements may subject the money transfer entity fines and possibly loss of licenses required to provide money transfer services, and may subject employees of the money transfer entity to monetary fins and/or imprisonment. Thus, compliance with the regulatory requirements is a priority for any money transfer entity.

### BRIEF SUMMARY

The present disclosure is directed to systems, methods, computer-readable storage media, and apparatuses for authorizing money transfer transactions in compliance with one or more regulatory requirements imposed on a money transfer entity. According to the present disclosure, a money transfer transaction is staged by a sending party. Staging the money transfer transaction may include providing staging information (e.g., sending party information, receiving party information, an amount of the money transfer, etc.) prior to the sending party interacting with an agent of the money transfer entity and providing payment to fund the money transfer transaction. The staging information may be used to initiate due diligence operations to ensure that the money transfer, if provided by the money transfer entity, is in compliance with any applicable regulatory requirements imposed by government agencies and/or any applicable regulatory/compliance requirements imposed by the money transfer entity. The due diligence operations may be performed prior to the sending party interacting with an agent of the money transfer entity and providing payment to fund the money transfer transaction.

Additionally, a receiving party may provide staging information that may be used to ensure compliance with applicable regulatory requirements imposed by the government agencies and/or the money transfer entity. The receiving party may provide the staging information prior to interacting with the agent of the money transfer entity to receive funds in connection with the money transfer transaction Staging transactions, and using staging information to perform due diligence operations, prior to the sending party and/or receiving party interacting with the agent of the money transfer entity may reduce operational costs for the money transfer entity, and may also reduce or eliminate delay in providing money transfer services to customers of the money transfer entity. Additionally, performing the due diligence operations prior to the sending party and/or receiving party interacting with the agent of the money transfer entity may increase a likelihood that money transfer transactions comply the applicable regulatory requirements, thereby reducing a likelihood that the money transfer entity will be assessed fines or other sanctions for failure to comply with the appropriate regulatory requirements. Furthermore, performing the due diligence operations prior to the sending party and/or receiving party interacting with the agent of the money transfer entity may reduce or eliminate instances where the money transfer entity is required to provide a refund to the sending party, such as when the due diligence operations indicate that the money transfer transaction cannot be completed due for regulatory compliance reasons.

The foregoing has outlined rather broadly the features and technical advantages of the present disclosure in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the scope of the present disclosure as set forth in the appended claims. The novel features which are believed to be characteristic of embodiments described herein, both as to its organization and method of operation, together with further objects and advantages will be better understood from the following written description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference should be made to the embodiments illustrated in greater detail in the accompanying drawings, wherein:

FIG. 1 is a block diagram of a system for authorizing outbound money transfer transactions in compliance with one or more regulatory requirements imposed on a money transfer entity;

FIG. 2 is a block diagram illustrating aspects of a system for authorizing inbound money transfer transactions in compliance with one or more regulatory requirements imposed on a money transfer entity; and

FIG. 3 is a flowchart illustrating aspects of a method for performing compliance auditing in connection with providing funds to a receiving part in connection with a money transfer transaction; and

FIG. 4 is a flowchart illustrating aspects of a method for performing compliance auditing in connection with providing funds to a receiving part in connection with a money transfer transaction.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

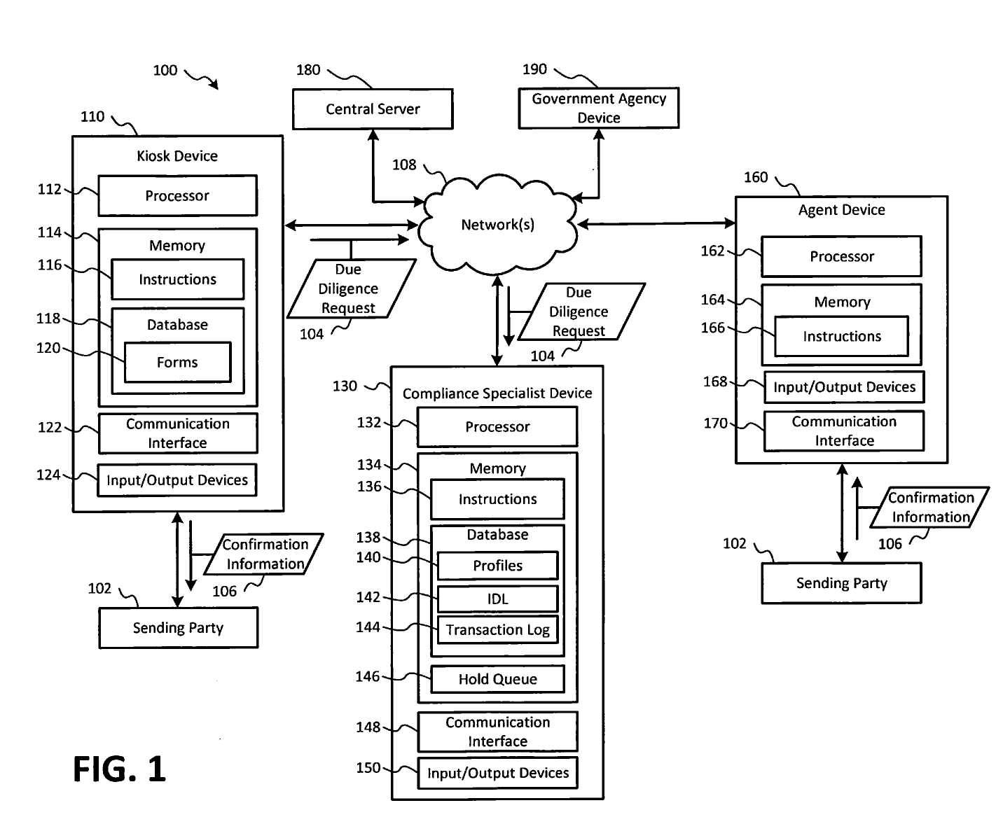

Referring to FIG. 1, a block diagram of a system for authorizing outbound money transfer transactions in compliance with one or more regulatory requirements imposed on a money transfer entity is shown as a system 100. As shown in FIG. 1, the system 100 includes a kiosk device 110, a compliance specialist device 130, an agent device 160, a network(s) 108, and a central server 180. Additionally, the system 100 may be in communication with a government agency device 190 via the network(s) 108.

The kiosk device 110 may be located at a money transfer location of a money transfer entity, such as a brick-and-mortar money transfer location, or may be located remote from the money transfer location, such as at a mall, a grocery store, etc. In an aspect, the kiosk device 110 may be a personal computer device, a tablet computing device, a mobile communication device, a smartphone device, a laptop computing device, another computing device, or a combination thereof. The kiosk device 110 includes a processor 112, a memory 114, a communication interface 122, and input/output (I/O) devices 124. The I/O devices 124 may include a signature pad, a camera, a pin pad module, a financial card reader, a biometric scanner, a receipt printer, another printing device, a barcode scanner, a metering device, a weight sensor, a check reader, a mouse, a keyboard, a touchscreen display device, a printer, a card scanner, a numeric keypad, a check reader, a microphone, a speaker, other types of input and output devices, or a combination thereof.

The memory 114 may include read only memory (ROM) devices, random access memory (RAM) devices, one or more hard disk drives (HDDs), one or more flash memory devices, one or more solid state drives (SSDs), other devices configured to store data in a persistent or non-persistent state, or a combination of different memory devices. The memory 114 may store instructions 116 that, when executed by the processor 112, cause the processor 112 to perform operations described in connection with the kiosk device 110 with reference to FIGS. 1-4.

In an aspect, the instructions 116 may include instructions that, when executed by the processor 112, cause the processor 112 to present various graphical user interfaces (GUIs) at a display device (not shown in FIG. 1) of the kiosk device 110. The GUIs may be configured to authenticate a resident in connection with a request to initiate a financial transaction. For example, a resident 102 may use a first GUI presented at the display device of the kiosk device 110 to provide a username and password. The kiosk device 110 may authenticate the resident 102's username, and, upon successful authentication of the resident 102, may present one or more additional GUIs to the resident 102. The one or more additional GUIs may enable the resident 102 to view a current balance of an account provided to the resident 102 by the controlled facility, to view a log of financial transactions that the resident 102 has completed, and to request a new financial transaction, as described in more detail below.

The communication interface 122 may be configured to communicatively couple the kiosk device 110 to one or more networks, such as the network(s) 108 via a wired or wireless connection established according to one or more communication protocols or standards (e.g., an Ethernet protocol, a transmission control protocol/internet protocol (TCP/IP), an institute of electrical and electronics engineers (IEEE) 802.11 protocol, and an IEEE 802.16 protocol, a 3^{rd} generation (3G) protocol, a 4^{th} generation (4G)/long term evolution (LTE) protocol, etc.). The kiosk device 110 may communicate with the agent device 120 and/or the electronic device 140 via the connection to the network(s) 108.

The network(s) 108 may include a wired network, a wireless network, or may include a combination of wired and wireless networks. For example, the network(s) 108 may be a local area network (LAN), a wide area network (WAN), a wireless WAN, a wireless LAN (WLAN), a metropolitan area network (MAN), a wireless MAN network, a cellular data network, a cellular voice network, the internet, etc. Additionally, the network(s) 108 may include multiple networks operated by different entities. For example, the network(s) 108 may include a first network provided by an internet service provider (ISP), a second network provided by the money transfer entity, and other networks (e.g., the internet) that communicatively couple the first network and the second network.

The compliance specialist device 130 includes a processor 132, a memory 134, a communication interface 148, and I/O device 150. The I/O devices 150 may include a camera, a printer, a mouse, a keyboard, a touchscreen display device, a printer, a numeric keypad, a microphone, a speaker, other types of input and output devices, or a combination thereof. The memory 134 may include ROM devices, RAM devices, one or more HDDs, one or more flash memory devices, one or more SSDs, other devices configured to store data in a persistent or non-persistent state, or a combination of different memory devices. The memory 134 may store instructions 136 that, when executed by the processor 132, cause the processor 132 to perform operations described in connection with the compliance specialist device 130 with reference to FIGS. 1-4. In an aspect, the compliance specialist device 130 may be a personal computer device, a tablet computing device, a mobile communication device, a smartphone device, a laptop computing device, another computing device, or a combination thereof.

In an aspect, the instructions 136 may include instructions that, when executed by the processor 132, cause the processor 132 to present various graphical user interfaces (GUIs) at a display device (not shown in FIG. 1) of the compliance specialist device 130. The GUIs may be configured to identify due diligence operations that may need to be performed, steps that a compliance specialist may use as a guide when performing the due diligence operations or a checklist of items to audit during the due diligence operations, or other information.

The communication interface 148 may be configured to communicatively couple the compliance specialist device 130 to one or more networks, such as the network(s) 108 via a wired or wireless connection established according to one or more communication protocols or standards (e.g., an Ethernet protocol, a TCP/IP protocol, an IEEE 802.11 protocol, and an IEEE 802.16 protocol, a 3G protocol, a 4G/LTE protocol, etc.). The compliance specialist device 130 may communicate with the kiosk device 110, the agent device 160, the central server 180, and/or the government agency device 190 via the connection to the network(s) 108.

The agent device 160 includes a processor 162, a memory 164, I/O devices 168, and a communication interface 170. The memory 164 may include ROM devices, RAM devices, one or more HDDs, one or more flash memory devices, one or more SSDs, other devices configured to store data in a persistent or non-persistent state, or a combination of different memory devices. The memory 164 may store instructions 166 that, when executed by the processor 162, cause the processor 162 to perform operations described in connection with the agent device 160 with reference to FIGS. 1-4. The communication interface 170 may be configured to communicatively couple the agent device 160 to one or more networks, such as the network(s) 108, as shown in FIG. 1. The communication interface 170 may be configured to communicatively couple the agent device 150 to the network(s) 108 via a wired or wireless connection established according to one or more communication protocols or standards (e.g., an Ethernet protocol, a TCP/IP protocol, IEEE 802.11 protocol, and an IEEE 802.16 protocol, a 3G protocol, a 4G/LTE protocol, etc.).

In an aspect, the agent device 160 may be a laptop computing device, a personal computing device, a tablet computing device, a point of sale (POS), a handheld POS, a smartphone, a mobile communication device, or any other electronic device operable to perform the operations of the agent device 160, as described with reference to FIGS. 1-4. The I/O devices 168 may include a money order printer, a signature pad, a camera, a pin pad module, a financial card reader, a biometric scanner, a receipt printer, another printing device, a barcode scanner, a metering device, a weight sensor, a check reader, a mouse, a keyboard, a touchscreen display device, a printer, a card scanner, a numeric keypad, a check reader, other types of input and output devices, or a combination thereof.

The central server 180 may include a processor, a memory, and a communication interface, not shown in FIG. 1. The memory may include read only memory (ROM) devices, random access memory (RAM) devices, one or more hard disk drives (HDDs), flash memory devices, solid state drives (SSDs), other devices configured to store data in a persistent or non-persistent state, or a combination of different memory devices. The memory may store instructions that, when executed by the processor, cause the processor to perform operations described in connection with the central server 180 with reference to FIGS. 1-4. Additionally, the memory may include one or more database storing information that may be accessible to the kiosk device 110, the compliance specialist device 130, and/or the agent device 160, as described in more detail below.

The government agency device 190 may include a processor, a memory, and a communication interface, not shown in FIG. 1. The memory may include ROM devices, RAM devices, one or more HDDs, flash memory devices, SSDs, other devices configured to store data in a persistent or non-persistent state, or a combination of different memory devices. The memory may store instructions that, when executed by the processor, cause the processor to perform operations described in connection with the government agency device 190 with reference to FIGS. 1-4. Additionally, the memory may include one or more database storing information that may be accessible to the kiosk device 110, the compliance specialist device 130, the agent device 160, and/or the central server 180, as described in more detail below.

During operation, the kiosk device 110 may receive a request to initiate a money transfer transaction between a sending party 102 and a receiving party (not shown in FIG. 1). For example, the sending party 102 may utilize the I/O devices 124 to interact with a graphical user interface (GUI) presented at a display device integrated with or communicatively coupled to the kiosk device 110 to generate the request to initiate the money transfer transaction. The GUI may prompt the sending party 102 with questions to capture information associated with the money transfer transaction. For example, the GUI may prompt the sending party 102 to provide sending party information that may be used to identify the sending party 102. The sending party information may include a name of the sending party 102, an address where the sending party 102 resides, a driver's license number or government issued identification number associated with the sending party 102, a passport number, a social security number, a tax identification number, a country of residence and/or citizenship of the sending party 102, an occupation of the sending party 102, a date of birth, other information associated with the sending party 102, or a combination thereof. The GUI may also prompt the sending party 102 to provide transaction information. The transaction information may include an amount of funds to be transferred in connection with the money transfer transaction, a date of the money transfer transaction, a purpose of the money transfer transaction, a name of a receiving party (not shown in FIG. 1) that is to receive funds in connection with the money transfer transaction, an address where the receiving party resides, a country of residence and/or citizenship information associated with the receiving party, other information associated with the requested money transfer transaction, or a combination thereof. In an aspect, the GUI may be presented using one or more of the forms 120 to prompt the sending party 102 to provide the information.

The kiosk device 110 may determine whether to place a hold on the money transfer transaction based, at least in part, on the staging information (e.g., the sending party information and the transaction information). If the hold is placed on the money transfer transaction, the sending party 102 may be prohibited from completing the money transfer transaction until further regulatory compliance auditing is performed, as described in more detail below. In an aspect, determining whether to place the hold on the money transfer transaction occurs prior to the sending party 102 interacting with an agent (e.g., an operator of the agent device 160) of the money transfer entity.

In an aspect, determining whether to place the hold on the money transfer transaction may include accessing a database to determine whether the sending party 102 is identified on a restricted sender list. The hold may be placed on the money transfer transaction when the sending party 102 is identified on the restricted sender list. In an aspect, the database may be operated by the money transfer entity and the restricted sender list may be an internal deny list (IDL) generated by the money transfer entity. For example, as shown in FIG. 1, an IDL 142 is stored at the database 138. The IDL 142 may identify persons and/or entities that are to be denied use of the money transfer services offered by the money transfer entity. The persons and entities identified in the IDL 142 may be determined by the money transfer entity based on internal regulatory compliance procedures and requirements, which may differ from regulatory requirements imposed by a government agency (e.g., an operator of the government agency device 190). In an aspect, the IDL 142 may be used to deny access to the money transfer services until a particular requested money transfer transaction has been audited by a compliance specialist (e.g., a user of the compliance specialist device 130). If the sending party 102 is identified in the IDL 142, a hold may be placed on the requested money transfer transaction, and the kiosk device 110 may initiate due diligence operations to determine whether the hold may be removed, as described in more detail below. In an aspect, the IDL 142 may be stored at a database remote to the compliance specialist device 130, such as the central server 180. In an additional or alternative aspect, the IDL 142 may be stored at the database 118 of the kiosk device 110. For security purposes, the IDL 142 may be encrypted.

In an additional or alternative aspect, the database may be operated by a government agency and the restricted sender list may be maintained by the government agency. For example, the government agency device 190 may be a server operated by the Office of Foreign Asset Control (OFAC), and the database may be stored at a memory of the government agency device 190. The restricted sender list may correspond a list of specially designated nationals, also known as the SDN list. The SDN list identifies individuals and companies owned or controlled by, or acting for or on behalf of, targeted countries designated by the United States government. The SDN list also identifies individuals, groups, and entities, such as terrorists and narcotics traffickers designated by the United States government under programs that are not country-specific. Assets of the individuals, groups, and entities identified by the SDN list may be blocked, and the individuals, groups, and entities are prohibited from dealing with U.S. persons and businesses. Thus, a money transfer entity may be prohibited from providing money transfer services to the sending party 102 if the sending party 102 is identified on the SDN list. In an aspect, the SDN list may be periodically retrieved from the government agency device 190 by an electronic device of the money transfer entity (e.g., the kiosk device 110, the compliance specialist device 130, and/or the central server 180).

In an additional or alternative aspect, the determination whether to place the hold on the money transfer transaction may be based on aggregation rules determined by the money transfer entity. The aggregation rules may be related to the frequency, volume, amount, etc. of money transfer transactions that an entity participates in as a sending party, as a receiving party, or both. The aggregation rules may be stored in the database 118 or may be stored remote to the kiosk device 110 (e.g., at the database 138 and/or a database of the central server 180). The aggregation rules may be determined by the money transfer entity based, at least in part, on the regulatory requirements imposed on the money transfer entity by a government agency (e.g., an operator of the government agency device 190).

In an aspect, the kiosk device 110 may determine a number of money transfer transactions that the sending party 102 has participated in during a period of time (e.g., a day, a week, a month, etc.). The kiosk device 110 may determine the number of money transfer transactions that the sending party 102 has participated in during the period of time based on a transaction log (not shown in FIG. 1) stored at the database 118, or based on a transaction log stored remote to the kiosk device 110. The transaction log stored remote to the kiosk device 110 may be the transaction log 144 stored at the database 138 of the compliance specialist device 130, or may be stored at a database (not shown in FIG. 1) of the central server 180. The transaction log may be a database of money transfer transactions that the sending party 102 has participated in as either a sending party or a receiving party. In an aspect, the kiosk device 110 may determine whether to place the hold on the money transfer transaction based on the aggregation rules by determining whether the number of money transfer transactions that the sending party 102 has participated in satisfies a threshold number of money transfer transactions during the period of time. The threshold number of money transactions may be a maximum number of money transfer transactions that an entity is permitted to participate in during the period of time (e.g., 10 money transfer transactions per day, per week, etc.).

The kiosk device 110 may determine whether to place the hold on the money transfer transaction based, at least in part, on whether the number of money transfer transactions that the sending party 102 has participated in satisfies the threshold number of money transfer transactions. In an aspect, the number of money transfer transactions that the sending party 102 has participated in during the time period may satisfy the threshold number of money transfer transactions when the number of money transfer transactions is less than the threshold number of money transfer transactions. In an additional or alternative aspect, the number of money transfer transactions that the sending party 102 has participated in during the time period may satisfy the threshold number of money transfer transactions when the number of money transfer transactions is less than or equal to the threshold number of money transfer transactions. In yet another additional or alternative aspect, the number of money transfer transactions that the sending party 102 has participated in during the time period may satisfy the threshold number of money transfer transactions when the number of money transfer transactions is greater than the threshold number of money transfer transactions. In yet another additional or alternative aspect, the number of money transfer transactions that the sending party 102 has participated in during the time period may satisfy the threshold number of money transfer transactions when the number of money transfer transactions is greater than or equal to the threshold number of money transfer transactions. When the number of money transfer transactions satisfies the threshold number of money transfer transactions, the kiosk device 110 may place the hold on money transfer transaction requested by the sending party 102, and may initiate due diligence operations to determine whether the hold may be removed, as described in more detail below.

In an aspect, the kiosk device 110 may determine an aggregate amount of transferred funds based on money transfer transactions that the sending party has participated in during the period of time. The kiosk device 110 may determine the aggregate amount of transferred funds based on a transaction log (not shown in FIG. 1) stored at the database 118, or based on a transaction log stored remote to the kiosk device 110. The transaction log stored remote to the kiosk device 110 may be the transaction log 144 stored at the database 138 of the compliance specialist device 130, or may be stored at a database (not shown in FIG. 1) of the central server 180. In an aspect, the kiosk device 110 may determine whether to place the hold on the money transfer transaction based on the aggregation rules by determining whether the aggregate amount of transferred funds satisfies a threshold amount. In an aspect, the aggregate amount of transferred funds associated with money transfer transactions that the sending party 102 has participated in during the time period may satisfy the threshold amount when the aggregate amount of transferred funds is less than the threshold amount. In an additional or alternative aspect, the aggregate amount of transferred funds associated with money transfer transactions that the sending party 102 has participated in during the time period may satisfy the threshold number of money transfer transactions when the aggregate amount of transferred funds is less than or equal the threshold amount. In an additional or alternative aspect, the aggregate amount of transferred funds associated with money transfer transactions that the sending party 102 has participated in during the time period may satisfy the threshold number of money transfer transactions when the aggregate amount of transferred funds is less than or equal the threshold amount. The kiosk device 110 may place the hold on money transfer transaction requested by the sending party 102 based on whether the number of money transfer transactions satisfies the threshold number of money transfer transactions, and may initiate due diligence operations to determine whether the hold may be removed, as described in more detail below.

In an aspect, the kiosk device 110 may access profile information to obtain a profile associated with the sending party 102, and may determine whether to place the hold on the money transfer transaction based, at least in part, on the profile information. For example, the kiosk device 110 may access profile information 140 stored at the database 138 to retrieve a profile associated with the sending party 102. In an additional or alternative aspect, the profile information may be stored at a database of the central server 180 or at the database 118. The profile information may be encrypted for security purposes.

In an aspect, determining whether to place the hold on the money transfer transaction based on the profile information may include determining, based on the staging information, whether information included in the profile of the sending party 102 has changed since a last time that the sending party 102 participated in a money transfer transaction. This may include determining whether the information included in the profile of the sending party 102 has changed since the last time that the sending party 102 participated in a money transfer transaction as a sending party, the last time that the sending party 102 participated in a money transfer transaction as a receiving party, or both. When the staging information includes different information for the sending party 102 (e.g., a different address, a different telephone number, etc.), the kiosk device 110 may determine that the one or more due diligence operations are required, and may initiate the one or more due diligence operations.

In an aspect, the profile associated with the sending party 102 may include a status indicator that indicates a result of due diligence operations performed during one or more previous money transfer transactions. The kiosk device 110 may set a value of the status indicator to a first value or a second value. In an aspect, the kiosk device 110 may set the value of the status indicator based on a result of the determination of whether the information included in the profile of the sending party 102 has changed since a last time that the sending party 102 participated in a money transfer transaction. For example, in response to a determination that the information included in the profile has changed since a last time that the sending party 102 participated in a money transfer transaction, the kiosk device 110 may set the status indicator included in the profile of the sending party 102 to a first value, where the first value indicates that the one or more due diligence operations are required prior to the sending party 102 participating in the money transfer transaction. As another example, in response to a determination that the information included in the profile has not changed since a last time that the sending party 102 participated in a money transfer transaction, the kiosk device 110 may set the status indicator to a second value, where the second value of the status indicator provides an indication that at least a portion of the due diligence operations were completed during a prior money transfer transaction that the sending party 102 participated in, and that the sending party 102 is allowed to participate in the money transfer transaction.

Including the status indicator in the profile of the sending party 102 may reduce an amount of due diligence operations that are performed when not needed. For example, if the sending party is identified in a restricted sender list, such as the SDN list described above, each time that the sending party 102 participates in a money transfer transaction, due diligence operations must be performed to determine whether the sending party 102 is allowed to participate in the money transfer transaction or whether the sending party 102 is prohibited from participating in the money transfer transaction. The sending party 102 may be allowed to participate in the money transfer transaction despite being identified on the SDN list for a variety of reasons. For example, the sending party 102 may have a name that is common. Thus, the party identified in the SDN list may be another person having the same name as the sending party 102, rather than identifying the sending party 102 specifically. The money transfer entity may employ persons (e.g., compliance specialists) that are trained to determine whether the sending party 102 has been specifically identified in the SDN list or whether the name identified in the SDN list is another person having the same name as the sending party 102. Because the restricted sender list (e.g., the SDN list) is checked each time the sending party 102 participates in a money transfer transaction, the compliance specialist must make the determination of whether the sending party 102 has been specifically identified in the SDN list or whether the name identified in the SDN list is another person having the same name as the sending party 102 each time that the sending party 102 participates in a money transfer transaction. This may create an additional burden on the compliance specialists.

To illustrate, assume that the sending party 102 desires to participate in a first money transfer transaction to send funds to a first receiving party (e.g., a first child) and a second money transfer transaction to send funds to a second receiving party (e.g., a second child). The status indicator of the profile for the sending party 102 may be set to the first value, indicating that due diligence operations must be performed before the sending party 102 may participate in the first money transfer transaction. The sending party 102 may be identified in a restricted sender list (e.g., the SDN list), and the kiosk device 110 may initiate due diligence operations associated with the first money transfer transaction. As a result of the due diligence operations performed in connection with the first money transfer transaction, the sending party 102 may be allowed to participate in and complete the first money transfer transaction. During the second money transfer transaction, which may occur immediately following the completion of the first money transfer transaction, the sending party 102 may be identified in the restricted sender list, and the kiosk device 110 may initiate due diligence operations again despite the due diligence operations having been previously performed just prior to the second money transfer transaction being initiated and despite the previously performed due diligence operations resulting in the sending party 102 being allowed to complete the first money transfer transaction. Thus, the second instance of performing the due diligence operations may be unnecessary (i.e., since the due diligence operations performed in connection with the first money transfer transaction resulted in the sending party being allowed to participate in the first money transfer transaction).

In an aspect, when the due diligence operations performed in connection with the first money transfer transaction result in the sending party 102 being cleared to participate in the first money transfer transaction, the status indicator included in the profile of the sending party 102 may be set to the second value to indicate that the sending party 102 is allowed to participate in money transfer transactions. Thus, during the second money transfer transaction, the kiosk device 110 may determine that the sending party 102 is able to participate in money transfer transactions and may forgo at least a portion of the due diligence operations, such as due diligence operations associated with determining whether the sending party 102 is the same party identified in the restricted sender list. If the sending party 102 subsequently attempts a third money transfer transaction using different staging information (e.g., a different address of residence, a different telephone number, etc.), the kiosk device 110 may determine that the information included in the profile has changed relative to the staging information, and may set the value of the status indicator to the first value, indicating that the one or more due diligence operations are required prior to the sending party 102 participating in the money transfer transaction.

In an aspect, the status indicator may provide multiple indications, each associated with a different due diligence operation or set of due diligence operations. For example, the status indicator may include a first indicator that provides an indication of a result of due diligence operations associated with determining whether the sending party 102 is identified in the restricted sender list or whether the sending party 102 merely has a name that is common to another party that is identified in the restricted sender list (i.e., another person sharing the same name as the sending party 102 is the party identified in the restricted sender list). If the sending party 102 is the party identified in the restricted sender list, then the first indicator may be set to the first value to indicate that the sending party 102 is prohibited from participating in money transfer transactions. If the sending party 102 is not the party identified in the restricted sender list, then the first indicator may be set to the second value to indicate that the sending party 102 is allowed to participate in money transfer transactions. As another example, the status indicator may include a second indicator that indicates whether the sending party 102 has participated in a number of money transfer transactions during a time period that satisfies the threshold number of money transfer transactions. The second indicator may be set to the first value or the second value depending on whether the number of money transfer transactions that the sending party 102 participated in during the time period that satisfies the threshold number of money transfer transactions. As yet another example, the status indicator may include a third indicator that indicates whether an aggregate amount of transferred funds sent and/or received the sending party 102 during a time period that satisfies the threshold amount. The third indicator may be set to the first value or the second value depending on whether the aggregate amount of transferred funds sent and/or received by the sending party 102 during the time period that satisfies the threshold amount.

It is noted that the multiple indicators described herein are provided by way of illustration, rather than limitation, and other indicators may be included in the status indicator associated with the profile of a party to a money transfer transaction. Additionally, it is noted that although the multiple indicators are described as including three indicators, more than three or less than three indicators may be included in the status indicator associated with the profile of a party to a money transfer transaction. Additionally, different profiles may be associated with status indicators having a different number of indicators. For example, a first party may be associated with a profile including a single indicator, a second party may be associated with a profile including two indicators, and a third party may be associated with a profile including more than two indicators. The number of indicators included in the status indicator may be determined based on a risk level associated with the profile of the respective parties, as described in more detail below.

In an aspect, the status indicator may be periodically reset following a period of inactivity. For example, if the sending party 102 does not participate in a money transfer transaction for a predetermined number of days, the status indicator may be automatically set to the first value, indicating that a next time the sending party 102 participates in a money transfer transaction, the due diligence operations are to be performed. When a time period between consecutive money transfer transactions that the sending party 102 participates in is less than the predetermined number of days, the status indicator may remain set to the second value so long as the profile information is not determined to have changed and other restriction checks (e.g., aggregation rules, etc.) do not prohibit the sending party 102 from participating in the money transfer transaction.

In an additional or alternative aspect, when the status indicator includes multiple indicators, as explained above, each of the multiple indicators (e.g., the first indicator, the second indicator, and the third indicator) may be periodically reset following a period of inactivity or for other reasons. Each of the multiple indicators may be associated with a different predetermined number of days (e.g., a different period of inactivity) and may be reset independent of other indicators. For example, the first indicator may be reset following a first predetermined number of days during which the sending party 102 has not participated in a money transfer transaction, while the second indicator may be reset following a second predetermined number of days during which the sending party 102 has not participated in a money transfer transaction, where the first predetermined number of days and the second predetermined number of days may be different. In an aspect, the resetting of the multiple indicators may include resetting different indicators to different values. For example, the first indicator may be reset to the first value following a first period of inactivity, where the first value indicates that a hold is to be placed on any money transfer transaction that the sending party 102 participates in until after the due diligence operations are completed, and the second indicator may be reset to the second value following a period of inactivity, where the second value indicates that a hold is not required for a money transfer transaction that the sending party 102 is participating in. If all of the multiple indicators are set to the second value, then a hold may not be required for a money transfer transaction that the sending party 102 is participating in. However, if at least one of the multiple indicators is set to the first value, the hold is required and at least a portion of the due diligence operations must be performed before the sending party 102 is permitted to participate in the money transfer transaction

In an aspect, the profiles included in the profile information 140 may include a risk level. The risk level may be used to identify a set of due diligence operations that are to be performed (if required) in connection with a money transfer transaction. For example, a first risk level may identify due diligence operations associated with verifying that the sending party 102 is not identified in a restricted sender list and initiating a communication to the sending party 102, as described in more detail below. A second risk level may identify due diligence operations associated with presenting one or more electronic forms for the sending party 102 to fill out, as described in more detail below. The particular risk level associated with a profile may be initially determined based on due diligence operations performed during a first transaction that the sending party 102 participates in. Additionally, the particular risk level may change over time. For example, the first time the sending party 102 participates in a money transfer transaction, the risk level may be set to the first risk level, and upon completion of the due diligence operations, the particular risk level may be set to the second risk level. The risk level may be periodically reset to a highest risk level (i.e., a risk level identifying a greater number of due diligence operations to be performed during a next money transfer transaction) following a period of inactivity. The risk level may also be modified in response to detecting, based on the staging information, changes in the profile information.

In response to a determination to place a hold on the money transfer transaction, the kiosk device 110 may initiate one or more due diligence operations to determine whether to remove the hold on the money transfer transaction. The kiosk device 110 may determine the one or more due diligence operations to be performed in connection with the requested money transfer transaction based on the staging information. The kiosk device 110 may analyze the staging information to determine the identity of the sending party 102, which may be used to retrieve the profile associated with the sending party 102. The kiosk device 110 may determine whether to forgo at least a portion of the due diligence operations based on whether the profile of the sending party 102 is different from the staging information. Additionally or alternatively, the kiosk device 102 may determine whether to forgo at least a portion of the due diligence operations based on the status indicator included in the profile associated with the sending party 102. For example, when the status indicator is a singular status indicator (e.g., the status indicator does not include multiple indicators) and is set to the first value, the kiosk device 110 may determine that the due diligence operations are to be performed. When the status indicator is set to the second value, the kiosk device 110 may forgo the due diligence operations.

When the status indicator includes the multiple indicators, the kiosk device 110 may determine whether to forgo at least a portion of the due diligence operations based on the values of the multiple status indicators. For example, if the first indicator is set to the first value, the kiosk device 110 may determine that due diligence operations are required to determine whether the sending party 102 is identified in the restricted sender list, and, if the first indicator is set to the second value, the kiosk device 110 may forgo due diligence operations associated with determining whether the sending party 102 is identified in the restricted sender list. The kiosk device 110 may determine, based on a value of other indicators of the multiple indicators, whether to forgo other due diligence operations, where each of the other indicators may be associated with one or more due diligence operations.

The kiosk device 110 may initiate execution of at least the portion of the due diligence operations when the status indicator is set to the first value, and may forgo at least the portion of the due diligence operations when the status indicator is set to the second value. Additionally or alternatively, the kiosk device 110 may initiate execution of the due diligence operations in response to a determination that the staging information is different from the profile associated with the sending party 102.

In an aspect, the one or more due diligence operations may include presenting one or more electronic forms to the sending party 102. The one or more electronic forms may be included in the forms 120 stored in the database 118. The one or more electronic forms may be required for compliance with particular government regulations that impose restrictions on the transfer of funds to particular countries. For example, the United States government has imposed sanctions that apply to money transfer transactions (e.g., remittances) to nationals of particular countries, where the frequency and amount of permitted transfers vary depending on the purpose of the transfer. A party desiring to participate in a money transfer transaction with a receiving party that resides in one of the particular countries may be required to sign an affidavit stating the purpose of the transfer, the amount of the transfer, and the identity of the receiving party. Thus, the one or more forms presented to the sending party 102 may include an affidavit. In an aspect, the one or more forms may be determined based on the staging information. For example, when the staging information indicates that the sending party 102 is requesting to initiate a money transfer transaction with a receiving party in a country that requires an affidavit, the kiosk device 110 may present the appropriate affidavit to the sending party 102.

As another example, the one or more electronic forms may include forms containing information descriptive of terms and conditions associated with the providing of the money transfer transaction by the money transfer entity, as required by some government regulations. The terms and conditions may include information descriptive of a fee charged by the money transfer entity for providing the requested money transfer transaction, information descriptive of an amount funds to be provided to the receiving party in connection with the requested money transfer transaction, an exchange rate used by the money transfer entity to determine the amount of funds to be provided to the receiving party, a type of currency to be used to provide the amount of funds to the receiving party, a date when the amount of funds will be available for pickup by the receiving party, contact information for the money transfer entity providing the money transfer transaction, or a combination thereof. It is noted that the one or more electronic forms presented to the sending party 102 may include forms other than an affidavit and/or terms and conditions information, and that the exemplary forms described above are provided by way of illustration, rather than by way of limitation.

The kiosk device 110 may receive inputs for one or more data fields included in the one or more electronic forms. The inputs may be provided via one or more of the I/O devices 124. The kiosk device 110 may populate the one or more data fields using the inputs, in response to a determination that all of the one or more data fields have been populated, the kiosk device 110 may transmit a due diligence request 104 to the compliance specialist device 130. The due diligence request 104 may include the one or more electronic forms that have been filled out and may include the staging information. In an aspect, the due diligence request 104 may include other information, such as information indicating particular due diligence operations to be completed by the compliance specialist (e.g., the user of the compliance specialist device).

When received by the compliance specialist device 130, the due diligence request 104 may be placed in a hold queue 146. The hold queue 146 may store due diligence requests received from the kiosk device 110 and other kiosk devices (not shown in FIG. 1). The other kiosk devices may include other kiosk devices located at a same location as the kiosk 110, and/or other kiosk devices located remote from (e.g., in a different store, a different city, a different state, a different country, etc.) the kiosk device 110. Additionally or alternatively, the hold queue may be located at the central server 180 and the due diligence request 104 may be transmitted from the kiosk device 110 to the central server 180. The central server 180 may then distribute the due diligence requests to compliance specialist devices, such as the compliance specialist device 130.

The central server 180 may distribute the due diligence requests to the compliance specialist devices using load balancing techniques to minimize the amount of time between receiving the due diligence requests and completing the due diligence operations performed by the compliance specialist. The load balancing techniques may include a round robin technique, a lowest average wait time technique, an area of expertise technique, other load balancing techniques, or a combination thereof. The round robin technique may provide due diligence requests to the compliance specialist device one at a time such that no compliance specialist device receives a second due diligence request until all compliance specialist devices has received a first due diligence request. The lowest average wait time technique may provide due diligence requests to the compliance specialist devices based on an average wait time (e.g., a lowest average amount of time for a due diligence request to be disposed of). The area of expertise technique may provide due diligence request to the compliance specialist devices based on particular due diligence operations that are to be performed. For example, id a due diligence request requires a compliance specialist to determine whether a sending party is the party identified in a restricted sender list, the due diligence request may be provided to a compliance specialist device associated with a compliance specialist that has received specialized training on determining whether the sending party is the party identified in the restricted sender list. This may reduce an amount of time required to perform the due diligence operations, and may reduce an amount of time that the sending party must wait before completing the money transfer transaction.

The due diligence operations may include initiating a communication (not shown in FIG. 1) to the sending party 102. Initiating the communication to the sending party 102 may include sending a text message to the sending party 102 or to a communication device associated with the sending party 102, such as the sending party 102's cell phone, initiating a telephone call to a wireless communication device (e.g., the sending party 102's cell phone) associated with the sending party 102, initiating a video call to the sending party 102, initiating a chat session with the sending party 102, prompting the sending party 102 to contact the money transfer entity to provide additional information in connection with the requested money transfer transaction, and initiating presentation of a virtual assistant to the sending party 102.

The text message may include a telephone number associated with a compliance specialist (e.g., an operator of the compliance specialist device 130) that is auditing the requested money transfer transaction for compliance with the applicable regulatory requirements. In an aspect, the text message may be generated by the compliance specialist device 130 that has been assigned the due diligence request 104. In an additional or alternative aspect, the text message may be generated by the central server 180 in response to assigning the due diligence request to the compliance specialist device 130. The text message may be communicated to the communication device of the sending party 102 via the network(s) 170. The telephone number of the sending party 102's communication device may be determined using the profile information 140 (e.g., a profile of the sending party 102) or may be determined using the staging information included in the due diligence request 104. Additionally, the text message may include a time at which the sending party 102 is to call the telephone number associated with the compliance specialist. This may reduce an amount of time that the sending party 102 is placed on hold, and may also reduce an overall amount of time required to complete the due diligence operations.

When the due diligence operations include initiating a telephone call to the sending party 102, the compliance specialist device 130 (or the central server 180) may initiate the telephone call in response to a determination that the compliance specialist associated with the compliance specialist device 130 is available. Stated another way, the compliance specialist device 130 (or the central server 180) may determine that the due diligence request 104 is a next due diligence request to be processed by the compliance specialist associated with the compliance specialist device 130, and upon detecting that a previous due diligence request has been completed, may initiate the telephone call to the sending party 102. By automatically initiating the telephone call to the sending party 102 when the compliance specialist that is performing the due diligence operations associated with the due diligence request 104 is available, an amount of time that the sending party is placed on hold may be reduced or eliminated. Additionally, because the sending party 102 does not have to call the compliance specialist, an amount of time that the compliance specialist spends waiting for the sending party 102 to call may be reduced or eliminated. This may reduce an overall amount of time required to complete the due diligence operations and reduce an amount of time required to authorize the sending party 102 to participate in the requested money transfer transaction. In an aspect, the text message including the telephone number associated with the compliance specialist may be transmitted to the sending party 102 if the sending party 102 does not answer the telephone call initiated by the compliance specialist device 130 (or the central server 180).

When the due diligence operations include initiating the video call to the sending party 102, the video call may be established between the compliance specialist device 130 and the kiosk device 110. Thus, when the sending party 102 requests the money transfer transaction, a face-to-face interview may facilitated between the sending party 102 and the compliance specialist operating the compliance specialist device 130. During the video call, the compliance specialist may present additional forms to be completed and other information to the sending party 102. Additionally, during the video call, the compliance specialist may ask the sending party 102 questions that may assist the compliance specialist in determining whether the sending party 102 is identified in a restricted sender list. Initiating the video call may facilitate real-time or near real-time regulatory compliance auditing, thereby greatly reducing an amount of time required to complete the due diligence operations and reducing an amount of time that the sending party 102 must wait before completing the money transfer transaction.

When the due diligence operations include initiating a chat session with the sending party 102, the chat session may be established between the compliance specialist device 130 and the kiosk device 110 or between the compliance specialist device 130 and the communication device of the sending party 102. Thus, when the sending party 102 requests the money transfer transaction, an interview may facilitated between the sending party 102 and the compliance specialist operating the compliance specialist device 130. During the chat session, the compliance specialist may present additional forms to be completed and other information to the sending party 102. Additionally, during the chat session, the compliance specialist may ask the sending party 102 questions that may assist the compliance specialist in determining whether the sending party 102 is identified in a restricted sender list. Initiating the chat session may facilitate real-time or near real-time regulatory compliance auditing, thereby greatly reducing an amount of time required to complete the due diligence operations and reducing an amount of time that the sending party 102 must wait before completing the money transfer transaction.

When the compliance specialist is auditing the due diligence request 104 to determine whether to authorize the requested money transfer transaction, the compliance specialist may require additional information from the sending party 102. Thus, the compliance specialist may provide inputs to the compliance specialist device 130 to indicate the additional information that is needed, which may include additional forms to be completed, additional information about the receiving party, additional information about the sending party 102, etc. The compliance specialist device 130 may then transmit a message to the kiosk device 110 that causes the kiosk device 110 to prompt the sending party 102 to provide the additional information. If the sending party 102 has logged out of the kiosk device 110, the sending party 102 may be prompted (e.g., via a text message or automated voice call) to login to the kiosk device 110 to provide the additional information.

Additionally, the due diligence operations may include initiating presentation of a virtual assistant to the sending party 102. The virtual assistant may be presented to the sending party 102 at the kiosk device 110, and may provide guidance to the sending party 102 during completion of one or more forms. The virtual assistant may also provide explanations to the sending party 102, such as reasons for a requested money transfer transaction being denied, and provide an interactive GUI that may be used to provide additional information to the compliance specialist. If the additional information causes the requested money transfer transaction to be in compliance with the regulatory requirements, the requested money transfer transaction may be authorized for completion. Using a virtual assistant to collect additional information for the compliance specialists review may enable the compliance specialist to audit a greater number of money transfer transactions, since the compliance specialist does not have to spend time collecting the additional information from the sending party 102.

After completing the due diligence operations, the compliance specialist may provide an input to the compliance specialist device 103 indicating a result of the review of the due diligence request by the compliance specialist. The result of the review of the due diligence request may indicate whether the hold placed on the money transfer request should be removed (i.e., whether the sending party 102 is authorized to participate in the requested money transfer transactions). A message including the result of the review may be provided to the kiosk device 110. In response to receiving the message, the kiosk device 110 may determine whether to remove the hold based on the result of the review. The hold may be removed when the result of the review indicates that the requested money transfer transaction is in compliance with the regulatory requirements, and the hold may be maintained when the result of the review indicates that the requested money transfer transaction may not comply with the regulatory requirements.

The kiosk device 110 may present information descriptive of the requested money transfer transaction to the sending party 102 in response to the determination to remove the hold on the money transfer transaction. For example, the kiosk device 110 may present information indicating an amount of the requested money transfer transaction, information associated with the intended recipient of the money transfer transaction, a summary of the terms and conditions (e.g., fees, exchange rate, amount of funds to be received by the receiving party, etc.), or other information. The kiosk device 110 may prompt the sending party 102 to provide an input to confirm the information descriptive of the requested money transfer transaction. If the information presented to the sending party 102 is incorrect, the sending party 102 may modify the information. Once the sending party 102 is satisfied that the information is correct, the sending party 102 may provide an input to the kiosk device 110 to confirm the information associated with the requested money transfer transaction. If the information is modified, the kiosk device 110 may verify that the modified information does not violate the aggregation rules, as described above.

In response to receiving an input confirming the information descriptive of the requested money transfer transaction, the kiosk device 110 may provide confirmation information 106 to the sending party 102 in response to a determination to remove the hold on the money transfer transaction. The confirmation information 106 may include a numeric code, an alpha-numeric code, a barcode, a quick response (QR) code, another form of code, or a combination thereof. The confirmation information 106 may authorize the sending party 102 to complete the money transfer transaction. In an aspect, the confirmation information 106 may be provided to the sending party 102 via a text message or an e-mail message delivered to the mobile communication device associated with the sending party 102. In an additional or alternative aspect, the kiosk device 110 may generate a receipt that includes the confirmation information 106. The receipt may also include other information, such as all or a portion of the confirmed details of the money transfer transaction, a telephone number associated with the compliance specialist that audited the requested money transfer request, a telephone number and address of a location where the kiosk device 110 is located and/or a telephone number and address of a money transfer entity or franchisee of the money transfer entity that operates the kiosk device 110, other information, or a combination thereof.

After receiving the confirmation information 106, the sending party 102 may visit a checkout counter at a money transfer location and present a money transfer agent (e.g., an employee of the money transfer entity) with the confirmation information 106. The money transfer agent may then provide inputs to the agent device 160 to initiate the money transfer transaction requested by the sending party 102. The agent device 160 may validate the confirmation information 106 based on the inputs. For example, upon generating the confirmation information 106, the kiosk device 110 may create an entry in the transaction log information 144 that identifies the requested money transfer transaction. The entry may initially be created as a requested and authorized money transfer transaction and may include the conformation information 106. The agent device 160 may access the entry using the inputs provided by the money transfer agent to validate the confirmation information 106. If the confirmation information 106 matches the confirmation information included in the entry in the transaction log (e.g., the confirmation information 106 is valid), the agent device 160 may prompt the money transfer agent with a total amount of the money transfer transaction (e.g., the amount of funds to be transferred plus an fees charged by the money transfer entity). The sending party 102 may provide funds satisfying the total amount of the money transfer transaction to the money transfer agent to fund the money transfer transaction. Thus, the money transfer agent operating the agent device 160 does not interact with the sending party 102, does not receive payment for the money transfer transaction, and does not initiate the money transfer transaction until after the confirmation information 106 has been provided to the sending party 102 and the requested money transfer transaction has been audited and approved by the compliance specialist. This may allow the money transfer agent to complete money transfer transactions more quickly and to server more sending and receiving parties, and may also reduce an amount of time that the sending party 102 has to wait to complete the money transfer transaction.

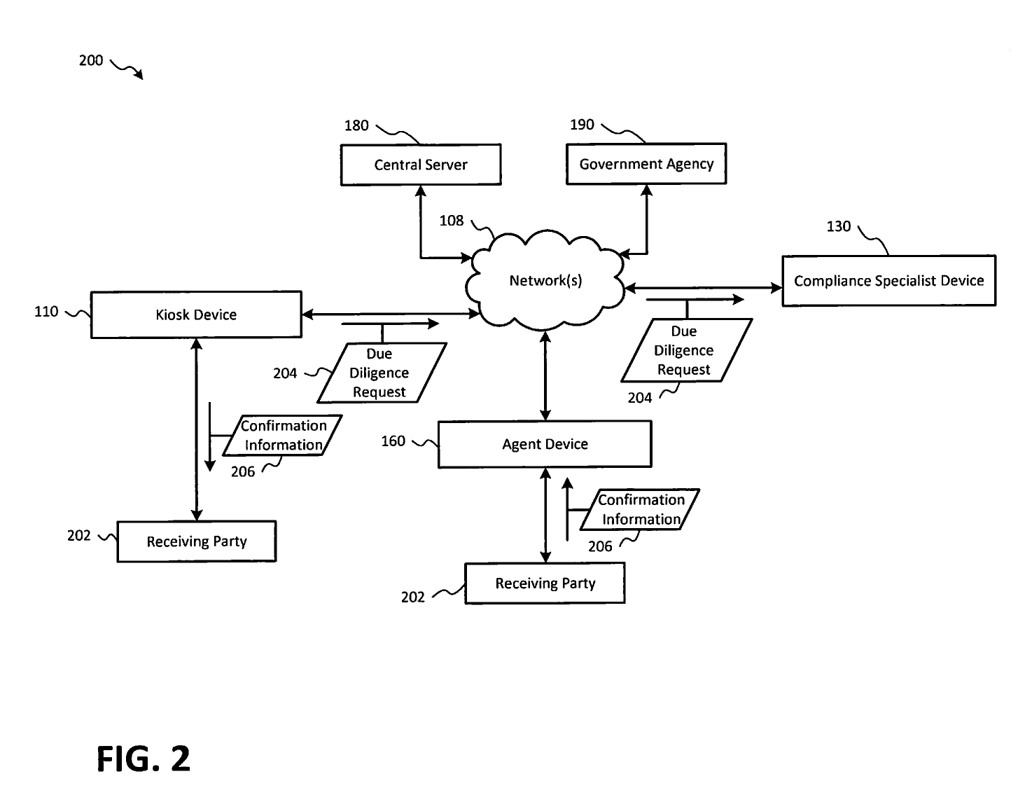

In an aspect, when the payment is received by the money transfer agent, the agent device 160 may update the entry in the transaction log 144 to indicate that payment has been received. In response to updating the entry in the transaction log 144, the compliance specialist device (or the kiosk device 110 or the central server 180) may generate additional confirmation information that may be provided to the receiving party. The receiving party may use the additional confirmation information to complete the money transfer transaction and receive funds, as described with reference to FIG. 2.

In an aspect, an electronic device other than the kiosk device 110 may be used to stage money transfer transactions and to initiated due diligence operations. For example, the money transfer entity may provide an application that may be executed on a wireless communication device, such as a smartphone, and the sending party 102 may provide the staging information via inputs provided to the application. The application may be configured to communicate the staging information to the central server 180, and the central server 180 may determine whether to place the hold on the requested money transfer transaction, such as by performing aggregation rule checks, performing restricted sender list checks, etc. If the central server 180 determines that a hold is to be placed on the money transfer transaction, the central server may generate and provide a due diligence request to a compliance specialist device, as described above. If the due diligence operations performed in response to the due diligence request result in the sending party 102 being authorized to initiate the money transfer transaction, the confirmation information 106 may be provided to the sending party 102 via a text message, an e-mail message, or a message accessible via the application executing on the sending party 102's wireless communication device. Thus, the sending party 102 may stage the money transfer transaction and receive authorization to participate in the money transfer transaction prior to visiting a money transfer location.

By providing the due diligence requests to the compliance specialist devices, the money transfer agent (who may or may not specialize in auditing money transfer requests for compliance with regulatory requirements) operating the agent device 160 does not need to be involved in completing or initiating the due diligence operations. This may reduce an amount of time required to complete a money transfer transaction once the due diligence operations have been completed and the sending party 102 has been authorized to participate in the money transfer transaction. For example, because the money transfer transactions are staged and the due diligence operations are completed prior to the sending party 102 interacting with the money transfer agent, the amount of time required to complete the money transfer transaction, once authorized, may be reduced. This may reduce an amount of time that a customer (e.g., a sending or receiving party) of the money transfer entity has to wait in line to complete money transfer transactions, and may increase the customer's satisfaction with the money transfer services provided by the money transfer entity. Additionally, because the money transfer agent does not perform the due diligence operations, a number of employees staffed for a particular time period by the money transfer entity may be reduced, thereby reducing a cost to operate a money transfer location (e.g., a brick-and-mortar money transfer location). Furthermore, by providing the due diligence requests to the compliance specialist devices operated by compliance specialists (e.g., employees of the money transfer entity specially trained to verify regulatory requirements compliance), the likelihood that a completed money transfer transaction will be in compliance with the regulatory requirements is increased and the likelihood that a completed money transfer transaction is not in compliance with the regulatory requirements may be reduced. Thus, the system 100 improves the technical field of money transfer services by reducing customer wait times, increasing a likelihood of regulatory compliance, and reducing a cost to operate a money transfer location.

Still further, the system 100 of FIG. 1 may facilitate real-time or near real-time compliance auditing (e.g., using video calls, chat sessions, telephone calls, etc.) for requested money transfer transactions, as described above. By providing the compliance auditing in real-time or near real-time and before the sending party 102 provides payment for the requested money transfer transaction, a number of money transfer transactions that are cancelled after payment is received by the money transfer agent may be reduced or eliminated. This may reduce or eliminate losses associated with refunding the funds provided to fund a money transfer transaction that is subsequently cancelled for regulatory compliance related reasons. For example, in a typical refund scenario, the money transfer entity may incur costs of approximately $100 per refund. Considering that the money transfer entity and its agents may process thousands or tens of thousands of money transfer requests on a weekly/monthly basis, the potential costs incurred through refunds for transactions that are cancelled for regulatory compliance purposes may add up quickly, imposing a substantial burden on the money transfer entity. The system 100 of FIG. 1 may reduce or eliminate this burden. Additionally, processing a refund may take several days or even weeks to complete, introducing a delay in returning the funds to the sending party 102. By reducing or eliminating the number of money transfer transactions that are funded prior to performing regulatory compliance auditing, the system 100 of FIG. 1 may reduce or eliminate the delay in providing funds to the sending party 102 in connection with a refund.

Referring to FIG. 2, a block diagram of a system for authorizing inbound money transfer transactions in compliance with one or more regulatory requirements imposed on a money transfer entity is shown as a system 200. As shown in FIG. 2, the system 200 includes the kiosk device 110, the compliance specialist device 130, the agent device 160, the network(s) 108, and the central server 180 of FIG. 1. Additionally, the system 200 may be in communication with the government agency device 190 via the network(s) 108.

During operation, the kiosk device 110 may receive a request to complete a money transfer transaction between a sending party (e.g., the sending party 102 of FIG. 1) and a receiving party 202. The request may include staging information. The staging information may include information associated with an identity of the receiving party 202 and other information. For example, the staging information provided to the kiosk device 110 by the receiving party 202 may include a code (e.g., a barcode, a QR code, an alpha-numeric code, a numeric only code, etc.) that identifies the money transfer transaction that the receiving party 202 desires to complete (e.g., receive funds for). In an aspect, the receiving party may provide the staging information to the kiosk device 110 using one or more graphical user interfaces and the I/O devices 124 of FIG. 1. In an additional or alternative aspect, the receiving party 202 may provide the staging information by scanning or providing the code to the kiosk device 110, where the code may be used by the kiosk device 110 to retrieve the staging information from a database (e.g., a database of the central server 180 or another device).

The kiosk device 110 may determine whether to place a hold on the money transfer transaction based, at least in part, on the staging information provided by the receiving party 202. When the hold is placed on the money transfer transaction, the receiving party 202 may be prohibited from receiving funds in connection with the money transfer transaction (e.g., the money transfer transaction described with reference to FIG. 1). In an aspect, the kiosk device 110 may determine whether to place the hold on the money transfer transaction using the staging information, as described with reference to FIG. 1. For example, using the stating information, the kiosk device 110 may access profile information (e.g., the profile information 140 of FIG. 1) to obtain a profile associated with the sending party 202, a restricted sender list (e.g., the IDL 142 of FIG. 1), and transaction log information (e.g., the transaction log information 144 of FIG. 1) when determining whether to place the hold on the money transfer transaction, as described with reference to FIG. 1. The transaction log information may be used to determine whether to place a hold on the money transfer transaction based on aggregation rules (e.g., whether the receiving party 202 has participated in a number of money transfer transactions that satisfies the threshold number of money transfer transactions, or whether an aggregate amount of funds transferred by or to the receiving party 202 satisfies a threshold amount), as described above with respect to FIG. 1.

In response to a determination to place a hold on the money transfer transaction, the kiosk device 110 may initiate one or more due diligence operations to determine whether to remove the hold on the money transfer transaction. The one or more due diligence operations may include presenting one or more electronic forms to the receiving party 202, initiating a communication (not shown in FIG. 2) to the receiving party 202, sending a text message to the receiving party 202 or to a communication device associated with the receiving party 202, such as the receiving party 202's cell phone, initiating a telephone call to the communication device associated with the receiving party 202, initiating a video call to the receiving party 202, initiating a chat session with the receiving party 202, prompting the receiving party 202 to contact the money transfer entity to provide additional information in connection with the requested money transfer transaction, and initiating presentation of a virtual assistant to the receiving party 202, as described above with reference to FIG. 1. In an aspect, initiating the due diligence operations may include transmitting a due diligence request 204 to the compliance specialist device 130 and/or the central server 180. If required, the compliance specialist may perform all or part of the due diligence operations to determine whether to remove the hold on the money transfer transaction.

Based on a result of the due diligence operations, the hold may or may not be removed, and the money transfer transaction may or may not be completed and the funds provided to the receiving party 202. In response to a determination to remove the hold on the money transfer transaction (e.g., when a result of the compliance specialist's audit of the money transfer transaction indicates that the money transfer transaction is in compliance with the applicable government regulatory requirements and internal compliance requirements), the kiosk device 110 may provide confirmation information 206 to the receiving party 202. The confirmation information 206 may authorize the receiving party 202 to receive the funds in connection with the money transfer transaction. The confirmation information 206 may be provided to the receiving party 202 via a text message or an e-mail message delivered to the mobile communication device associated with the receiving party 202. In an additional or alternative aspect, the kiosk device 110 may generate a receipt that includes the confirmation information 206. The receipt may also include other information, such as all or a portion of the confirmed details of the money transfer transaction, a telephone number associated with the compliance specialist that audited the requested money transfer request, a telephone number and address of a location where the kiosk device 110 is located and/or a telephone number and address of a money transfer entity or franchisee of the money transfer entity that operates the kiosk device 110, other information, or a combination thereof.

The sending party 202 may provide the confirmation information 206 to the money transfer agent (e.g., the employee operating the agent device 160), who may validate the confirmation information 206, as described with reference to FIG. 1, and, after validating the confirmation information 206, may provide the funds to the receiving party 202 to complete the money transfer transaction. For example, the money transfer agent may provide inputs associated with the confirmation information, such as the code, to the agent device 160, and the agent device 160 may validate the confirmation information 106 based on the inputs. For example, the agent device 160 may access the entry included in the transaction log (e.g., the entry created when the confirmation information was provided to the sending party 102, as described with reference to FIG. 1) based on the input provided by the money transfer agent to validate the confirmation information 106. If the confirmation information 206 matches the confirmation information included in the entry in the transaction log (e.g., the confirmation information 206 is valid), the agent device 160 may prompt the money transfer agent with a total amount of funds to be provided to the sending party 202 to complete the money transfer transaction. In an aspect, at the time the confirmation may information is provided to the sending party and the entry in the transaction log is created, additional confirmation information (e.g., the confirmation information 206) for use by the receiving party 202 may be generated. The confirmation information 206 may be provided to the receiving party 202 upon receipt of payment for the money transfer transaction from the sending party, as described with reference to FIG. 1.

In an aspect, an electronic device other than the kiosk device 110 may be used to stage money transfer transactions and to initiated due diligence operations. For example, the money transfer entity may provide an application that may be executed on a wireless communication device, such as a smartphone, and the receiving party 202 may provide the staging information via inputs provided to the application. The application may be configured to communicate the staging information to the central server 180, and the central server 180 may determine whether to place the hold on the requested money transfer transaction, such as by performing aggregation rule checks, performing restricted sender list checks, etc. If the central server 180 determines that a hold is to be placed on the money transfer transaction, the central server may generate and provide a due diligence request to a compliance specialist device, as described above. If the due diligence operations performed in response to the due diligence request result in the receiving party 202 being authorized to receive funds in connection with the money transfer transaction, the confirmation information 206 may be provided to the receiving party 202 via a text message, an e-mail message, or a message accessible via the application executing on the receiving party 202's wireless communication device. Thus, the receiving party 202 may stage the money transfer transaction and receive authorization to participate in the money transfer transaction prior to visiting a money transfer location.

By providing the due diligence requests to the compliance specialist devices, the money transfer agent (who may or may not specialize in auditing money transfer requests for compliance with regulatory requirements) operating the agent device 160 does not need to be involved in completing or initiating the due diligence operations. This may reduce an amount of time required to complete a money transfer transaction once the due diligence operations have been completed and the receiving party 202 has been authorized to receive funds in connection with the money transfer transaction. For example, because the money transfer transactions are staged and the due diligence operations are completed prior to the receiving party 202 interacting with the money transfer agent, the amount of time required to complete the money transfer transaction, once authorized, may be reduced. This may reduce an amount of time that a customer (e.g., a sending or receiving party) of the money transfer entity has to wait in line to complete money transfer transactions, and may increase the customer's satisfaction with the money transfer services provided by the money transfer entity. Additionally, because the money transfer agent does not perform the due diligence operations, a number of employees staffed for a particular time period by the money transfer entity may be reduced, thereby reducing a cost to operate a money transfer location (e.g., a brick-and-mortar money transfer location). Furthermore, by providing the due diligence requests to the compliance specialist devices operated by compliance specialists (e.g., employees of the money transfer entity specially trained to verify regulatory requirements compliance), the likelihood that a completed money transfer transaction will be in compliance with the regulatory requirements may increase and the likelihood that a completed money transfer transaction is not in compliance with the regulatory requirements may be reduced. Thus, the system 100 improves the technical field of money transfer services by reducing customer wait times, increasing the likelihood of regulatory compliance, and reducing a cost to operate a money transfer location. Still further, the system 200 of FIG. 2 may facilitate real-time or near real-time compliance auditing (e.g., using video calls, chat sessions, telephone calls, etc.) for requested money transfer transactions, as described above and as also described with reference to FIG. 1.

In an aspect, at least a portion of the due diligence operations performed in connection with the receiving party 202 may be performed simultaneously with the due diligence operations associated with the sending party (e.g., the due diligence operations describes with reference to FIG. 1). For example, the staging information provided by the sending party may include enough information to enable a compliance specialist to perform due diligence operations with respect to the receiving party 202 while another compliance specialist (or the same compliance specialist) performs due diligence operations with respect to the sending party. This may eliminate situations where the sending party is authorized to send the funds, but the receiving party is not authorized to receive the funds (e.g., due to aggregation rules, information included in a restricted sender list, etc.). Thus, in some aspects, a number of money transfer transactions that are cancelled after payment is received by the money transfer agent may be reduced or eliminated. This may also reduce or eliminate losses associated with refunding the funds provided to fund a money transfer transaction that is subsequently cancelled for regulatory compliance related reasons, such as when the receiving party 202 is not authorized to receive the funds despite the sending party being authorized to send the funds. For example, in a typical refund scenario, the money transfer entity may incur costs of approximately $100 per refund. Considering that the money transfer entity and its agents may process thousands or tens of thousands of money transfer requests on a weekly/monthly basis, the potential costs incurred through refunds for transactions that are cancelled for regulatory compliance purposes may add up quickly, imposing a substantial burden on the money transfer entity. The system 200 of FIG. 2 may reduce or eliminate this burden. Additionally, processing a refund may take several days or even weeks to complete, introducing a delay in returning the funds to the sending party. By reducing or eliminating the number of money transfer transactions that are funded prior to performing regulatory compliance auditing, the system 200 of FIG. 2 may reduce or eliminate the delay in providing funds to the sending party in connection with a refund, and may reduce or eliminate the likelihood that the receiving party 202 visits a money transfer location to receive funds only to find out that the receiving party 202 is not authorized to receive the funds.

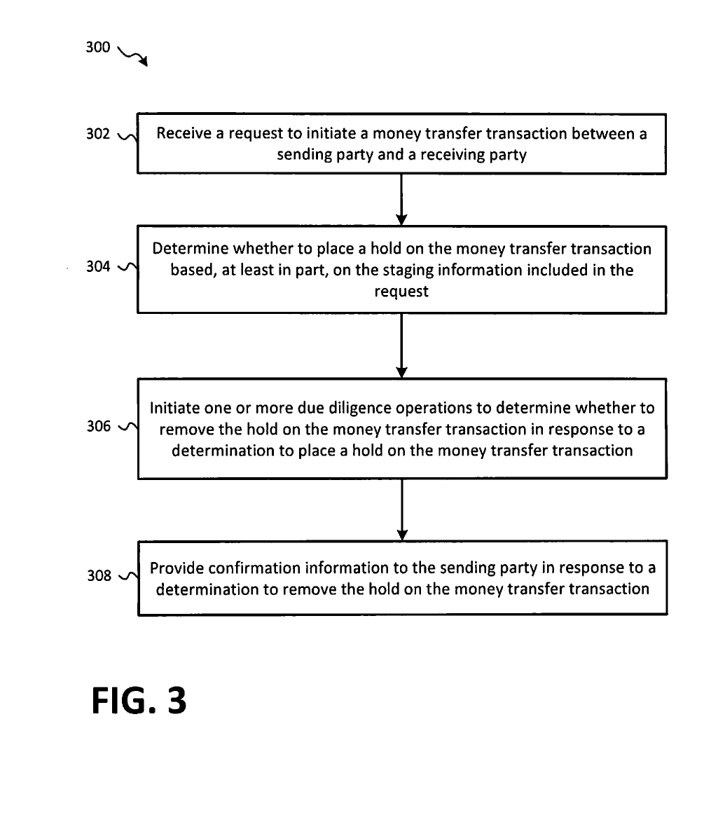

Referring to FIG. 3, a flowchart illustrating aspects of a method for performing compliance auditing in connection with a requested money transfer transaction is shown as a method 300. In an aspect, the method 300 may be performed by an electronic device, such as the kiosk device 110, by the compliance specialist device 130 of FIG. 1, by the central server 180 of FIG. 1, by a mobile communication device executing an application provided by a money transfer entity, or a combination thereof. At 302, the method 300 includes receiving a request to initiate a money transfer transaction between a sending party and a receiving party. The request may include staging information that includes information associated with an identity of the sending party. In an aspect, the staging information may be the staging information described with reference to FIG. 1. In an aspect, the electronic device may present one or more graphical user interfaces (GUIs) to prompt the sending party to provide the staging information.

At 304, the method 300 includes determining whether to place a hold on the money transfer transaction based, at least in part, on the staging information. When the hold is placed on the money transfer transaction, the sending party may be prohibited from completing the money transfer transaction, at least until one or more conditions (e.g., reasons for placing the hold on the money transfer transaction) have been cleared, such as by completing due diligence operations. In an aspect, the determination whether to place the hold on the money transfer transaction may be performed as described with reference to FIG. 1, such as using aggregation rules, restricted sender list checks, etc.

At 306, the method 300 includes initiating one or more due diligence operations to determine whether to remove the hold on the money transfer transaction. The due diligence operations may be initiated in response to a determination to place a hold on the money transfer transaction, as described with reference to FIG. 1. In an aspect, the due diligence operations may include initiating a communication to the sending party. The communication may include a text message sent to the sending party or to a communication device associated with the sending party, such as the sending party's cell phone, a telephone call to a wireless communication device associated with the sending party, a video call to the sending party, initiating a chat session with the sending party, prompting the sending party (e.g., presenting information at a display screen of the kiosk device or in a message sent to an electronic device associated with the sending party) to contact the money transfer entity to provide additional information in connection with the requested money transfer transaction, presenting a virtual assistant to the sending party, or other due diligence operations, as described with reference to FIG. 1.

At 308, the method 300 includes providing confirmation information to the sending party in response to a determination to remove the hold on the money transfer transaction. The confirmation information may authorize the sending party to participate in the money transfer transaction. As described with reference to FIG. 1, the money transfer transaction may be initiated using funds provided by the sending party after validation of the confirmation information by a money transfer entity (e.g., a money transfer agent operating an agent device).

By staging the money transfer transaction and performing the due diligence operations prior to the sending party providing funds to the money transfer agent, the method 300 may reduce an amount of time during which the sending party interacts with the money transfer agent, thereby allowing the money transfer agent to process money transfer transactions more quickly. Additionally, the method 300 may reduce an amount of time that the sending party has to wait in line to complete money transfer transactions, and may increase the sending party's satisfaction with the money transfer services provided by the money transfer entity. Additionally, the method 300 may reduce a cost to operate a money transfer location (e.g., a brick-and-mortar money transfer location) because the money transfer agent does not perform the due diligence operations, allowing a reduced a number of employees staffed at the money transfer location for a particular time period. Furthermore, the likelihood that a completed money transfer transaction will be in compliance with the regulatory requirements may increase and the likelihood that a completed money transfer transaction is not in compliance with the regulatory requirements may be reduced because the money transfer request is pre-authorized by a compliance specialist that is specially trained to audit money transfer transaction requests for regulatory compliance. Thus, the method 300 improves the technical field of money transfer services by reducing customer wait times, increasing the likelihood of regulatory compliance, and reducing a cost to operate a money transfer location. Still further, the method 300 facilitates real-time or near real-time compliance auditing (e.g., using video calls, chat sessions, telephone calls, etc.) for requested money transfer transactions.

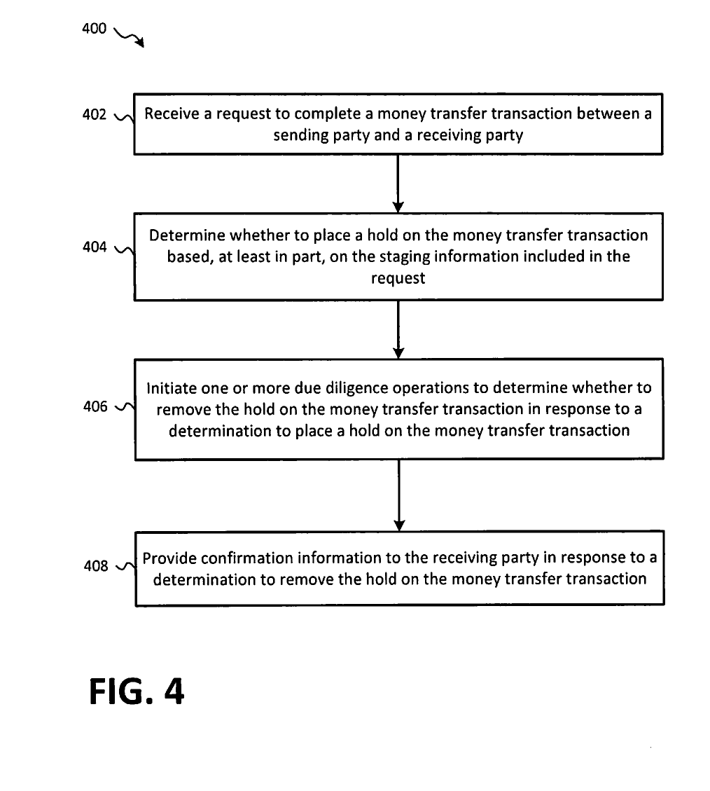

Referring to FIG. 4, a flowchart illustrating aspects of a method for performing compliance auditing in connection with providing funds to a receiving part in connection with a money transfer transaction is shown as a method 400. In an aspect, the method 400 may be performed by an electronic device, such as the kiosk device 110, by the compliance specialist device 130 of FIG. 1, by the central server 180 of FIG. 1, by a mobile communication device executing an application provided by a money transfer entity, or a combination thereof.

At 402, the method 400 includes receiving a request to complete a money transfer transaction between a sending party and a receiving party. The request may include staging information that includes information associated with an identity of the receiving party. In an aspect, the staging information may be the staging information described with reference to FIG. 2. In an aspect, the electronic device may present one or more graphical user interfaces (GUIs) to prompt the receiving party to provide the staging information.

At 404, the method 400 includes determining whether to place a hold on the money transfer transaction based, at least in part, on the staging information. When the hold is placed on the money transfer transaction, the receiving party may be prohibited from receiving funds in connection with the money transfer transaction, at least until one or more conditions (e.g., reasons for placing the hold on the money transfer transaction) have been cleared, such as by completing due diligence operations. In an aspect, the determination whether to place the hold on the money transfer transaction may be performed as described with reference to FIG. 1, such as using aggregation rules, restricted sender list checks, etc.

At 404, the method 400 includes, in response to a determination to place a hold on the money transfer transaction, initiating one or more due diligence operations to determine whether to remove the hold on the money transfer transaction. The due diligence operations may be initiated in response to a determination to place a hold on the money transfer transaction, as described with reference to FIGS. 1 and 2. In an aspect, the due diligence operations may include initiating a communication to the receiving party. The communication may include a text message sent to the receiving party or to a communication device associated with the receiving party, such as the receiving party's cell phone, a telephone call to a wireless communication device associated with the receiving party, a video call to the receiving party, initiating a chat session with the receiving party, prompting the receiving party (e.g., presenting information at a display screen of the kiosk device or in a message sent to an electronic device associated with the receiving party) to contact the money transfer entity to provide additional information in connection with the requested money transfer transaction, presenting a virtual assistant to the receiving party, or other due diligence operations, as described with reference to FIGS. 1 and 2.

At 408, the method 400 includes, providing confirmation information to the receiving party in response to a determination to remove the hold on the money transfer transaction. The confirmation information may authorize the receiving party to receive the funds in connection with the money transfer transaction, and the funds may be provided to the receiving party, thereby completing the money transfer transaction, after verification of the confirmation information by a money transfer entity (e.g., a money transfer agent operating an agent device).

By staging the money transfer transaction and performing the due diligence operations prior to the receiving party receiving funds in connection with a money transfer transaction, the method 400 may reduce an amount of time during which the receiving party interacts with the money transfer agent, thereby allowing the money transfer agent to process money transfer transactions more quickly. Additionally, the method 400 may reduce an amount of time that the receiving party has to wait in line to complete the money transfer transaction, and may increase the receiving party's satisfaction with the money transfer services provided by the money transfer entity. The method 400 may also reduce a cost to operate a money transfer location (e.g., a brick-and-mortar money transfer location) because the money transfer agent does not perform the due diligence operations, allowing a reduced a number of employees staffed at the money transfer location for a particular time period. Furthermore, the likelihood that a completed money transfer transaction will be in compliance with the regulatory requirements may increase and the likelihood that a completed money transfer transaction is not in compliance with the regulatory requirements may be reduced because the money transfer request is pre-authorized by a compliance specialist that is specially trained to audit money transfer transaction requests for regulatory compliance. Thus, the method 400 improves the technical field of money transfer services by reducing customer wait times, increasing the likelihood of regulatory compliance, and reducing a cost to operate a money transfer location. Still further, the method 400 facilitates real-time or near real-time compliance auditing (e.g., using video calls, chat sessions, telephone calls, etc.) for requested money transfer transactions.

In an aspect, the method 400 may be performed, in part or in its entirety, concurrently with (e.g., in parallel with) the method 300. For example, at least a portion of the due diligence operations performed in connection with the receiving party may be performed simultaneously with the due diligence operations associated with the sending party. This may eliminate situations where the sending party is authorized to send the funds, but the receiving party is not authorized to receive the funds (e.g., due to aggregation rules, information included in a restricted sender list, etc.). Thus, in some aspects, the methods 300 and 400 may reduce or eliminate a number of money transfer transactions that are cancelled after payment is received by the money transfer agent, and may reduce or eliminate losses associated with refunding the funds provided to fund a money transfer transaction that is subsequently cancelled for regulatory compliance related reasons.

Although the embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method comprising:
receiving, by a processor, a request to initiate a money transfer transaction between a sending party and a receiving party, wherein the request includes staging information that includes information associated with an identity of the sending party;
determining, by the processor, whether to place a hold on the money transfer transaction based, at least in part, on the staging information, wherein, when the hold is placed on the money transfer transaction, the sending party is prohibited from completing the money transfer transaction;
in response to a determination to place a hold on the money transfer transaction, initiating, by the processor, one or more due diligence operations to determine whether to remove the hold on the money transfer transaction; and
in response to a determination to remove the hold on the money transfer transaction, providing, by the processor, confirmation information to the sending party, wherein the confirmation information authorizes the sending party to complete the money transfer transaction, and wherein the money transfer transaction is initiated using funds provided by the sending party after verification of the confirmation information by a money transfer entity.

2. The method of claim 1, wherein determining whether to place the hold on the money transfer transaction includes accessing a database to determine whether the sending party is identified on a restricted sender list, wherein the hold is placed on the money transfer transaction when the sending party is identified on the restricted sender list.

3. The method of claim 2, wherein the database is an Office of Foreign Asset Control (OFAC) database and the restricted sender list is a list of specially designated nationals.

4. The method of claim 2, wherein the restricted sender list is an internal deny list (IDL) generated by a money transfer entity.

5. The method of claim 1, wherein the one or more due diligence operations include:
presenting one or more electronic forms to the sending party;
receiving inputs for one or more data fields included in each of the one or more electronic forms; and
populating the one or more data fields using the inputs.

6. The method of claim 5, wherein the one or more due diligence operations include:
in response to populating the one or more electronic forms, transmitting the one or more electronic forms to an electronic device associated with a compliance specialist for review; and
receiving a message indicating a result of the review of the one or more electronic forms by the compliance specialist, wherein the determination to remove the hold is based, at least in part, on the result of the review of the one or more electronic forms by the compliance specialist.

7. The method of claim 1, wherein the one or more due diligence operations include initiating a communication to the sending party.

8. The method of claim 7, wherein initiating the communication includes at least one of: sending a text message to the sending party, initiating a telephone call to a wireless communication device associated with the sending party, initiating a video call to the sending party, initiating a chat session with the sending party, prompting the sending party to contact a money transfer entity to provide additional information in connection with the money transfer, and initiating presentation of a virtual assistant to the sending party.

9. The method of claim 1, wherein the method includes:
determining a number of money transfer transactions that the sending party has participated in during a period of time;
determining whether the number of money transfer transactions satisfies a threshold number of money transfer transactions; and
determining whether to place the hold on the money transfer transaction based, at least in part, on whether the number of money transfer transactions satisfies the threshold number of money transfer transactions.

10. The method of claim 1, wherein the method includes:
determining an aggregate amount of transferred funds based on money transfer transactions that the sending party has participated in during a period of time;
determining whether the aggregate amount of transferred funds satisfies a threshold amount; and
determining whether to place the hold on the money transfer transaction based, at least in part, on whether the whether the aggregate amount of transferred funds satisfies the threshold amount.

11. An apparatus comprising:
at least one processor; and
memory storing instructions that, when executed by the at least one processor, cause the at least one processor to perform operations including:
receiving a request to initiate a money transfer transaction between a sending party and a receiving party, wherein the request includes staging information that includes information associated with an identity of the sending party;
determining whether to place a hold on the money transfer transaction based, at least in part, on the staging information, wherein, when the hold is placed on the money transfer transaction, the sending party is prohibited from completing the money transfer transaction;
in response to a determination to place a hold on the money transfer transaction, initiating due diligence operations to determine whether to remove the hold on the money transfer transaction; and
in response to a determination to remove the hold on the money transfer transaction, providing confirmation information to the sending party, wherein the confirmation information authorizes the sending party to complete the money transfer transaction, and wherein the money transfer transaction is initiated using funds provided by the sending party after verification of the confirmation information by a money transfer entity.

12. The apparatus of claim 11, wherein the confirmation information includes a numeric code, an alpha-numeric code, a barcode, a quick response (QR) code, or a combination thereof.

13. The apparatus of claim 11, wherein the operations include:
accessing a profile associated with the sending party, wherein the profile includes a status indicator;
determining, based on the staging information, whether information included in the profile has changed since a last time that the sending party participated in a money transfer transaction;
in response to a determination that the information included in the profile has changed since a last time that the sending party participated in a money transfer transaction, setting the status indicator to a first value;
in response to a determination that the information included in the profile has not changed since a last time that the sending party participated in a money transfer transaction, setting the status indicator to a second value;
determining whether to forgo at least a portion of the due diligence operations based on the status indicator included in the profile;
executing at least the portion of the due diligence operations when the status indicator is set to the first value; and
forgoing at least the portion of the due diligence operations when the status indicator is set to the second value.

14. The apparatus of claim 13, wherein the second value of the status indicator provides an indication that at least the portion of the due diligence operations was completed during a prior money transfer transaction that the sending party participated in.

15. The apparatus of claim 11, wherein the due diligence operations include:
presenting one or more electronic forms to the sending party;
receiving inputs for one or more data fields included in each of the one or more electronic forms; and
populating the one or more data fields using the inputs.

16. The apparatus of claim 15, wherein the due diligence operations include:
in response to populating the one or more electronic forms, transmitting the one or more electronic forms to an electronic device associated with a compliance specialist for review; and
receiving a message indicating a result of the review of the one or more electronic forms by the compliance specialist, wherein the determination to remove the hold is based, at least in part, on the result of the review of the one or more electronic forms by the compliance specialist.

17. The apparatus of claim 15, wherein the one or more electronic forms include information descriptive of a fee charged by a money transfer entity for providing the requested money transfer transaction, information descriptive of an amount funds to be provided to a receiving party in connection with the requested money transfer transaction, an exchange rate used by the money transfer entity to determine the amount of funds to be provided to the receiving party, a type of currency to be used to provide the amount of funds to the receiving party, a date when the amount of funds will be available for pickup by the receiving party, contact information for the money transfer entity providing the money transfer transaction, or a combination thereof.

18. The apparatus of claim 11, wherein the operations include:
in response to the determination to remove the hold on the money transfer transaction, presenting information descriptive of the requested money transfer transaction to the sending party;
prompting the sending party to provide an input to confirm the information descriptive of the requested money transfer transaction; and
in response to receiving an input confirming the information descriptive of the requested money transfer transaction, providing the confirmation information to the sending party.

19. The apparatus of claim 18, wherein the operations include:
prompting the sending party to modify the requested money transfer transaction in response to receiving an input that does not confirm the information descriptive of the requested money transfer transaction;
receiving updated staging information for the requested money transfer transactions in response to the prompting; and
determining whether to initiate additional due diligence operations based on the updated staging information.

20. A computer-readable storage medium storing instructions that, when executed by a processor, cause the processor to perform operations comprising:
receiving a request to complete a money transfer transaction between a sending party and a receiving party, wherein the request includes staging information that includes information associated with an identity of the receiving party;
determining whether to place a hold on the money transfer transaction based, at least in part, on the staging information, wherein, when the hold is placed on the money transfer transaction, the receiving party is prohibited from receiving funds in connection with the money transfer transaction;
in response to a determination to place a hold on the money transfer transaction, initiating one or more due diligence operations to determine whether to remove the hold on the money transfer transaction; and
in response to a determination to remove the hold on the money transfer transaction, providing confirmation information to the receiving party, wherein the confirmation information authorizes the receiving party to receive the funds in connection with the money transfer transaction, and wherein the funds are provided to the receiving party to complete the money transfer transaction after verification of the confirmation information by a money transfer entity.

21. The computer-readable storage medium of claim 20, wherein determining whether to place the hold on the money transfer transaction includes accessing a database to determine whether the sending party is identified on a restricted sender list, wherein the database includes at least one of a government database and a database maintained by a money transfer entity, and wherein the hold is placed on the money transfer transaction when the sending party is identified on the restricted sender list.

22. The computer-readable storage medium of claim 20, wherein the operations include:
accessing a profile associated with the receiving party, wherein the profile includes a status indicator;
determining, based on the staging information, whether information included in the profile has changed since a last time that the receiving party participated in a money transfer transaction;
in response to a determination that the information included in the profile has changed since a last time that the receiving party participated in a money transfer transaction, setting the status indicator to a first value;
in response to a determination that the information included in the profile has not changed since a last time that the receiving party participated in a money transfer transaction, setting the status indicator to a second value;
determining whether to forgo at least a portion of the due diligence operations based on the status indicator included in the profile;
executing at least the portion of the due diligence operations when the status indicator is set to the first value; and
forgoing at least the portion of the due diligence operations when the status indicator is set to the second value.

23. The computer-readable storage medium of claim 22, wherein the second value of the status indicator provides an indication that at least the portion of the due diligence operations was completed during a prior money transfer transaction that the receiving party participated in.

24. The computer-readable storage medium of claim 20, wherein the one or more due diligence operations include:
resenting one or more electronic forms to the sending party;
receiving inputs for one or more data fields included in each of the one or more electronic forms;
populating the one or more data fields using the inputs;
in response to populating the one or more electronic forms, transmitting the one or more electronic forms to an electronic device associated with a compliance specialist for review; and
receiving a message indicating a result of the review of the one or more electronic forms by the compliance specialist, wherein the determination to remove the hold is based, at least in part, on the result of the review of the one or more electronic forms by the compliance specialist.

25. The computer-readable storage medium of claim 24, wherein the one or more due diligence operations include:
initiating a communication to the receiving party, wherein initiating the communication includes at least one of: sending a text message to the receiving party, initiating a telephone call to a wireless communication device associated with the receiving party, initiating a video call to the receiving party, initiating a chat session with the receiving party, prompting the receiving party to contact the compliance specialist to provide additional information in connection with the money transfer transaction, and initiating presentation of a virtual assistant to the receiving party,
wherein the message indicating the result of the review is provided based, at least in part, on information provided by the receiving party in response to the communication.

26. The computer-readable storage medium of claim 20, wherein the operations include:
determining a number of money transfer transactions that the receiving party has participated in during a period of time;
determining whether the number of money transfer transactions satisfies a threshold number of money transfer transactions; and
determining whether to place the hold on the money transfer transaction based, at least in part, on whether the number of money transfer transactions satisfies the threshold number of money transfer transactions.

27. The computer-readable storage medium of claim 20, wherein the operations include:
determining an aggregate amount of transferred funds based on money transfer transactions that the receiving party has participated in during a period of time;
determining whether the aggregate amount of transferred funds satisfies a threshold amount; and
determining whether to place the hold on the money transfer transaction based, at least in part, on whether the whether the aggregate amount of transferred funds satisfies the threshold amount.

28. The computer-readable storage medium of claim 20, wherein the operations include performing due diligence operations with respect to a sending party to the money transfer transaction concurrently with the due diligence operations performed with respect to the receiving party.
